(19) United States
(12) Patent Application Publication
(10) Pub. No.: US 2017/0280741 A1
(43) Pub. Date: Oct. 5, 2017

(54) EXTRACTION APPARATUS

(71) Applicant: CambTEK Limited, Cambridge (GB)

(72) Inventors: Hugh Malkin, Cottenham (GB); Nicholas James Hastings, Cambridge (GB); Ian Morgan George, Cottenham (GB); Martin Pearl, Gamlingay (GB)

(21) Appl. No.: 15/401,738

(22) Filed: Jan. 9, 2017

Related U.S. Application Data
(63) Continuation of application No. PCT/GB2015/052004, filed on Jul. 10, 2015.

(30) Foreign Application Priority Data
Jul. 10, 2014 (GB) 1412297.2

(51) Int. Cl. A23F 5/26; C11B 1/10; B01D 11/02

(52) U.S. Cl. CPC A23F 5/265; B01D 11/0215; C11B 1/10; C09H 3/00

(57) ABSTRACT

Apparatus for distributing a solid, gel, powder, granular, liquid or viscous liquid test substance in an extraction fluid comprises:
a) a flow cell for holding the test substance comprising an extraction chamber of uniform cross-sectional area, a grinding surface, an extraction fluid inlet and an extract outlet;
b) a grinding head disposed within the extraction chamber and adapted to reciprocate therein; and
c) a recirculating pump for driving extraction fluid: (i) into the flow cell via the extraction fluid inlet; (ii) through the extraction chamber; and (iii) back to the flow cell via the extract outlet.

### RELATED APPLICATIONS

This application is a continuation of and claims the benefit under 35 U.S.C. §120 and §365(c) of International Application No. PCT/GB2015/052004, with an international filing date of Jul. 10, 2015, and entitled “IMPROVED EXTRACTION APPARATUS”, the entire contents of which are herein incorporated by reference. This application also claims the benefit of priority of Great Britain Application No. 1412297.2, filed on Jul. 10, 2014, the entire contents of which are herein incorporated by reference.

### FIELD OF THE INVENTION

The invention relates to apparatus for distributing, dissolving and/or suspending a solid, gel, powder, granular, liquid or viscous liquid test substance in an extraction fluid, as well as to methods for distributing, dissolving and/or suspending a test substance in an extraction fluid and processes for producing extracted test products using such methods.

### BACKGROUND TO THE INVENTION

Dissolution or extraction of drug dosage forms is routinely used in drug quality control (e.g. to assess batch-to-batch consistency of solid oral dosage forms such as tablets) as well as in drug development (e.g. to predict in vivo drug release dynamics).

WO 2010/020752 describes an apparatus for the rapid extraction of drug dosage forms, including tablets, gels and powders. The apparatus includes a flow cell for holding the test substance and having an inlet and an outlet; an extraction chamber located between said inlet and outlet comprising a convergent nozzle; and a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet. The apparatus is used to progressively erode solid drug dosage forms by creating vigorous turbulence in which the disintegrating solids act “like sand blasting” to increase the rate of product extraction whilst avoiding the need for an “intrusive abrading device”, such as a “homogenizer”.

WO 2014/033429 also describes apparatus for the rapid extraction of drug dosage forms, including tablets, gels and powders. In a similar way to that described in WO 2010/020752, the apparatus is used to progressively erode solid drug dosage forms by creating vigorous turbulence, the flow cell comprising an extraction chamber located between said inlet and outlet comprising a convergent nozzle whereby a pressure differential is established across the extraction chamber such that the velocity of the extraction fluid is greater at the outlet than at the inlet.

In both WO 2010/020752 and WO 2014/033429 ultrasound and/or grooves within the flow cell are employed to accelerate extraction.

It has now been recognized that the apparatus as described in WO 2010/020752 and WO 2014/033429 cannot quickly or reliably extract certain solid dosage forms, including for example certain slow-release, sustained release or tamper-proof dosage forms. In particular, it has now also been discovered that progressive erosion, vigorous turbulence, high pressure and flow velocities, ultrasound and grooved extraction chambers as described in WO 2010/020752 and WO 2014/033429 do not permit the reliable extraction of certain slow-release, sustained release or tamper-proof dosage forms.

The present inventors have now discovered that mechanical crushing, grinding and/or cutting of the test substance is essential for the fast and reliable extraction of certain slow-release, sustained release or tamper-proof drug dosage forms. Moreover, the inventors have discovered that the incorporation of a mechanical crushing, cutting and/or grinding step obviates the need for the progressive erosion, vigorous turbulence, ultrasound and grooved extraction chambers of WO 2010/020752 and WO 2014/033429.

### SUMMARY OF THE INVENTION

In a first aspect there is provided an apparatus for distributing a solid, gel, powder, granular, liquid or viscous test substance in an extraction fluid, the apparatus comprising:
a) a flow cell for holding the test substance comprising an extraction chamber of uniform cross-sectional area, a grinding surface, an extraction fluid inlet and an extract outlet;
b) a grinding head disposed within the extraction chamber and adapted to reciprocate therein; and
c) a recirculating pump for driving extraction fluid: (i) into the flow cell via the extraction fluid inlet; (ii) through the extraction chamber; and (iii) back to the flow cell via the extract outlet.

Any solid, gel, powder, granular, liquid or viscous liquid test substance may be distributed (e.g. dissolved and/or suspended) according to the invention, including but not limited to drug samples (including pharmaceutical solid dose forms), environmental samples, cosmetics, herbal extracts, laboratory reagents and food samples.

Other aspects of the invention are as defined in the claims appended hereto.

### EXEMPLIFICATION

### BRIEF DESCRIPTION OF THE DRAWINGS

Embodiments of the present invention will now be described by way of example with reference to the accompanying drawings in which:

FIG. 1A illustrates schematically an apparatus embodying the present invention in a raised, first position.

FIG. 1B illustrates schematically an apparatus embodying the present invention in a lowered, second position.

FIG. 2 shows perspective views of the grinding head, showing a grinding head provided with ribs and also pierced with holes.

FIG. 3 shows perspective views of an alternative grinding head comprising blades provided with teeth to cut and pulverize the sample and notches which permit extraction fluid and pulverized test substance to flow through the grinding head during grinding, cutting, crushing and/or extraction.

FIG. 4A shows the results of 3 minutes extraction of a slow release (hydroxypropyl methylcellulose (HPMC) encapsulated) drug capsule as a test sample with the apparatus of the invention.

FIG. 4B shows the results of 35 minutes of extraction of the same drug capsule shown in FIG. 4A with prior art apparatus.

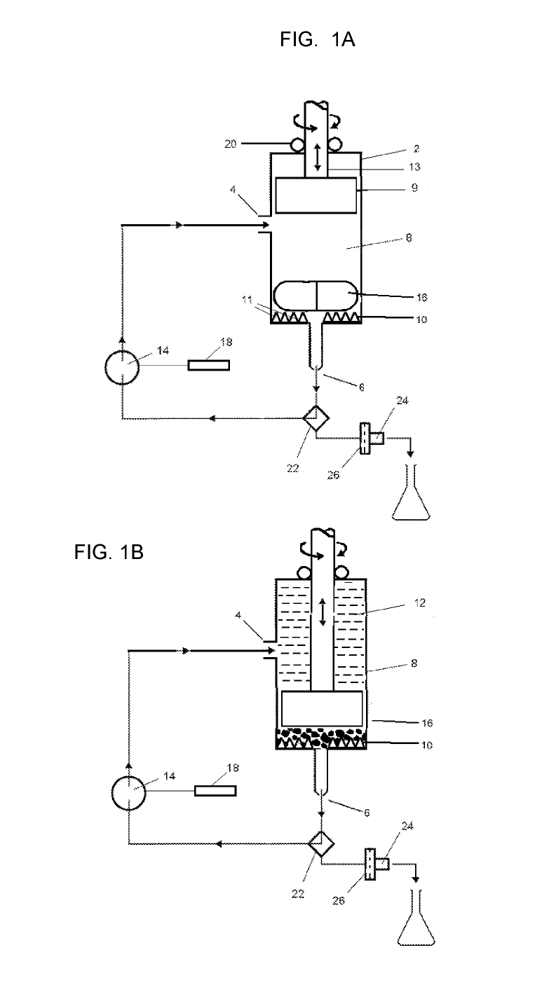

Referring to FIG. 1A, the apparatus includes a flow cell (2) having an extraction fluid inlet (4) and an extract outlet (6). Between the extraction fluid inlet (4) and the extract outlet (6), there is an extraction chamber (8) comprising a grinding surface (10) comprising a plurality of teeth (11).

Disposed within the extraction chamber (8) is a grinding head (9) mounted on a rotatable, reciprocating driving spindle (13). The grinding head is a loose fit within the chamber, so that fluid within the extraction chamber can flow around the grinding head. Reciprocation and rotation of the grinding head is effected by a motor (not shown) coupled to the spindle (13). The motor is actuated by a programmable controller (not shown).

In use, a test substance (16), here a drug capsule, is placed into the flow cell (2). The grinding head is then driven towards the grinding surface (10) (see FIG. 1B) while being continuously or intermittently rotated, so that the test substance is crushed, ground and pulverized between the grinding head (9) and the teeth (11) of the grinding surface (10). The grinding head is adapted so as to leave a small clearance gap between it and the grinding surface, such that attritional wear of the grinding head by the teeth of the grinding surface is avoided.

Extraction fluid (12), for example an aqueous solvent, is driven through the flow cell (2) before, during and/or after the grinding operation, passing from the extraction fluid inlet (4), through the extraction chamber (8) and out of the fluid outlet (6) by recirculating pump (14), and then back to the fluid inlet (4) to re-circulate the extraction fluid.

The crush and/or grind step may comprise: (a) one, two, three or greater than four reciprocations of the grinding head; and/or (b) uni- or bi-directional rotation of the grinding head. Alternatively, the crush and grind step may consist of a crushing unidirectional movement of the grinding head towards the grinding surface, with or without uni- or bi-directional rotation of the grinding head.

The duration and nature of the crush/grind operation is controlled by the operator and varies according to the sample to be extracted. The relative timings and frequency of the crushing, grinding and fluid extraction steps are also controlled by the operator and vary according to the sample to be extracted.

Control of the crush/grind operation is via a programmable controller (not shown). This actuates movement of the grinding head between a raised, first position (as shown in FIG. 1A and a lowered, second position FIG. 1B. In the first position, the grinding head is not in contact with the test substance (16), whilst in the second position the grinding head is in contact with the sample and approximately 0.5 mm from the grinding surface (10). The grinding head is moved to the second position by the application of a substantially constant force (e.g. by the action of a spring or application of a weight) to the grinding head (9) via the driving spindle (13).

Thus, depending on the nature (and in particular the hardness) of the test substance (16), the second position may not be assumed immediately on actuation of the movement from first to second position by the programmable controller, but rather may be reached (or approached) only after a period of grinding effected by rotation of the spindle, which progressively fragments and pulverizes the test substance, reducing its volume and permitting a gradual assumption of the second, (fully) lowered position.

It should be noted that the second, (fully) lowered position of the grinding head (9) may be assumed only after a period of extraction with the extraction fluid (12). For example, in cases where the test substance (16) is a tamper-proof encapsulated drug dose form, an initial “dry” crush/grind operation effects an approach to the second position, which is reached gradually in the course of concomitant extraction with the extraction fluid (12).

The use of a substantially constant force to drive the grinding head to a single (fully) lowered position permits gradual breakdown and diminution in volume of the test sample to proceed in a progressive manner whilst a crushing force is being applied by the grinding head.

It is, however, possible to drive the grinding head into a (fully) lowered position via a series of discrete intermediate positions through use of a (preferably clutched) driving motor programmed with intermediate stop positions.

In some cases the sample is first crushed and ground prior to the introduction of the extraction fluid. Such a “dry” crush and grind step may comprise: (a) one, two, three or greater than four reciprocations of the grinding head; and/or (b) uni- or bi-directional rotation of the grinding head. Alternatively, the crush and grind step may consist of a crushing unidirectional movement of the grinding head towards the grinding surface, with or without uni- or bi-directional rotation of the grinding head.

In other cases, the extraction fluid is driven through the flow cell extraction chamber before the crush and/or grind step. Such a “soak” step may be useful in circumstances where the sample is “softened” by exposure to extraction fluid such that a subsequent crushing or grinding operation is facilitated.

In yet other cases, the extraction fluid is driven through the flow cell extraction chamber during the crush and/or grind step. Such a “wet” crush and grind step may comprise: (a) one, two, three or greater than four reciprocations of the grinding head; and/or (b) uni- or bi-directional rotation of the grinding head. Alternatively, the crush and grind step may consist of a crushing unidirectional movement of the grinding head towards the grinding surface, with or without uni- or bi-directional rotation of the grinding head.

In all cases, pulverised test substance is ultimately dissolved, suspended and/or distributed throughout the extraction fluid.

Sealing means (20) retains extraction fluid within the extraction chamber whilst permitting rotation and reciprocation of the driving spindle (13).

The extraction fluid (12) is passed through the extraction chamber (8) by recirculating pump (14), controlled by controller (18) and the reciprocating and rotating grinding operation repeated until the drug capsule (16) has been fully broken up, dissolved, suspended and/or distributed throughout the extraction fluid, for instance in solution or as a suspension.

The pump is reversible and can be controlled by controller (18) to drive fluid in the reverse direction, when it passes back through the fluid outlet (6), extraction chamber (8) and through the extraction fluid inlet (4). Pump direction reversal may be used to clear any blockages in the fluid outlet (6).

Fluid outlet (6) may be provided with means (not shown) for retaining pulverized test substance within the extraction chamber.

Also provided is a collection valve (22) which is operable to redirect the extraction fluid flow to a collection port (24) so that extracted test substance can be collected for analysis. The collection port (24) is provided with a filter (26) so that suspensions are filtered prior to collection.

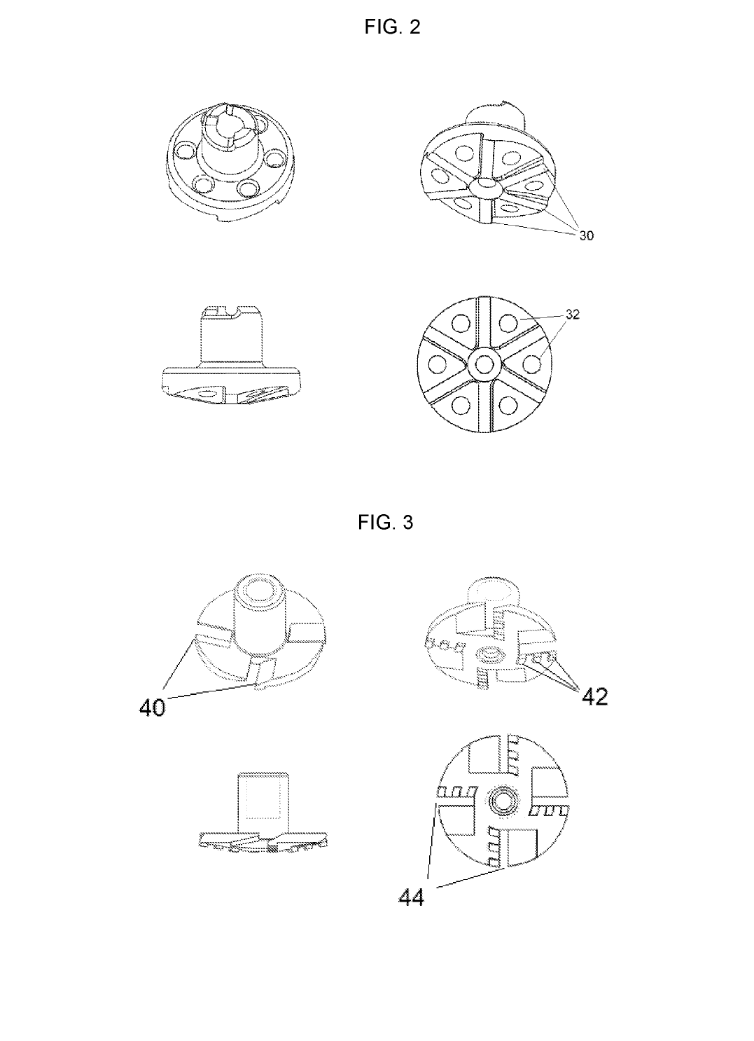

Referring now to FIG. 2, the grinding head is provided with ribs (30) to facilitate pulverization of the sample. The head is also pierced with holes (32) to permit extraction fluid and pulverized test substance to flow through the grinding head during grinding, crushing, cutting and/or extraction.

An alternative grinding head is shown in FIG. 3. This grinding head comprises blades (40) provided with teeth (42) to cut and pulverize the sample. This head is provided with notches (44) to permit extraction fluid and pulverized test substance to flow through the grinding head during grinding, cutting, crushing and/or extraction. This head may be particularly useful in the pulverization of samples comprised of a plurality of discrete solid drug dosage forms.

### COMPARATIVE EXAMPLE

The performance of the apparatus of the invention was compared to that of apparatus as described in WO 2010/020752 and WO 2014/033429 (prior art). Specifically, apparatus as described in FIGS. 1 and 2 of WO 2014/033429 was used to progressively erode a slow release solid drug capsule by creating vigorous turbulence during exposure to ultrasound and the results compared with the grinding apparatus of the invention as described above.

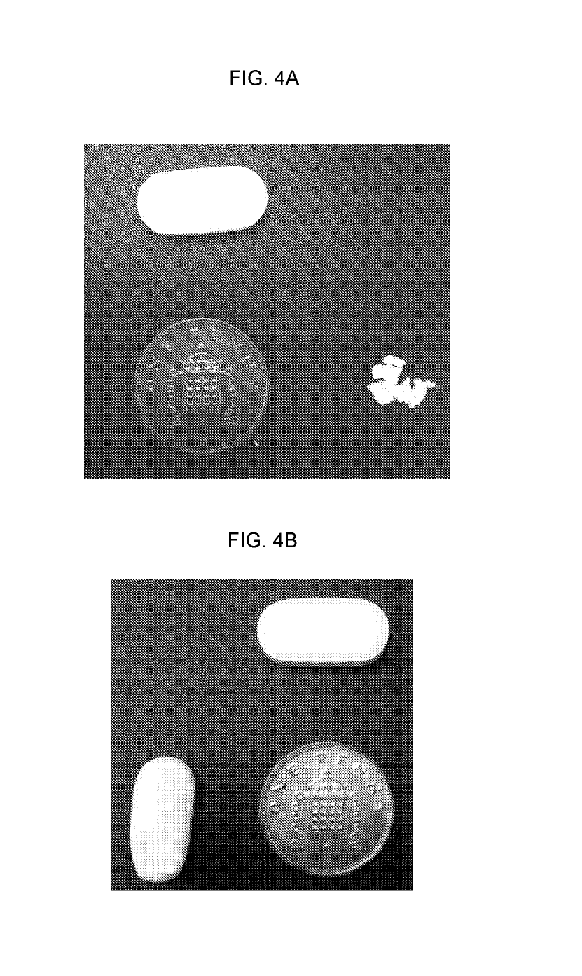

FIG. 4A shows the results of 3 minutes extraction of a slow release (hydroxypropyl methylcellulose (HPMC) encapsulated) drug capsule as a test sample with the apparatus of the invention. It can be seen that the sample is substantially extracted, leaving little residue, after the 3 minute extraction.

FIG. 4B shows the results of 35 minutes of extraction of the same drug capsule with the prior art apparatus. As can be seen from the photographs, the capsule is only superficially eroded even after a prolonged extraction time when using the prior art apparatus, whereas the present invention achieves almost complete extraction in less than a tenth of that extraction time.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

1. Apparatus for distributing a solid, gel, powder, granular, liquid or viscous liquid test substance in an extraction fluid, the apparatus comprising:
a) a flow cell for holding the test substance comprising an extraction chamber of uniform cross-sectional area, a grinding surface, an extraction fluid inlet and an extract outlet;
b) a grinding head disposed within the extraction chamber and adapted to reciprocate therein; and
c) a recirculating pump for driving extraction fluid: (i) into the flow cell via the extraction fluid inlet; (ii) through the extraction chamber; and (iii) back to the flow cell via the extract outlet.

2. The apparatus of claim 1 wherein the grinding head is further adapted to rotate within the extraction chamber.

3. The apparatus of claim 1 further comprising a motor for: (a) reciprocating the grinding head; and/or (b) rotating the grinding head, optionally bidirectionally.

4. The apparatus of claim 1 further comprising means for generating a substantially constant linear force on the grinding head towards the grinding surface.

5. The apparatus of claim 4 wherein the means for generating a substantially constant force on the grinding head comprises a weight, a coiled spring, a lever spring, gas spring, hydraulic strut, solenoid, servo-motor or stepper-motor.

6. The apparatus of claim 1 wherein the grinding head is a loose fit within the extraction chamber to permit extraction fluid and/or pulverized test substance to pass around the grinding head.

7. The apparatus of claim 1 wherein the grinding head comprises ridges, teeth, blades, spikes and/or abrasive particles disposed thereon for pulverizing the test substance.

8. The apparatus of claim 1 wherein the grinding head is pierced with one or more holes to permit extraction fluid and/or pulverized test substance to pass through the grinding head.

9. The apparatus of claim 1 wherein grinding head is adapted to mate with the grinding surface with a clearance gap at least 0.5 mm, at least 1.0 mm or at least 2.0 mm

10. The apparatus of claim 1wherein the grinding head and/or grinding surface comprise ridges, teeth, blades, spikes and/or abrasive particles disposed thereon for pulverizing the test substance.

11. The apparatus of claim 1wherein both grinding head and grinding surface comprise ridges, teeth, blades, spikes and/or abrasive particles disposed thereon for pulverizing the test substance.

12-15. (canceled)

16. The apparatus of claim 1 further comprising a collection valve for switching the flow of extraction fluid from a recirculating path to a collection port.

17. The apparatus of claim 16 wherein the flow to the collection port is via a filter.

18. The apparatus of claim 1 further comprising a solid, gel, powder, granular, liquid or viscous liquid test substance located within the flow cell.

19. The apparatus of claim 16 further comprising extraction fluid surrounding the test substance.

20. The apparatus of claim 1 wherein the grinding head is mounted on a driving rod or spindle.

21. A method for dissolving and/or suspending a solid, gel, powder, granular, liquid or viscous liquid test substance in an extraction fluid comprising the steps of: (a) introducing the test substance into the extraction chamber of an apparatus as defined in any one of the preceding claims; (b) crushing, grinding and/or cutting the test substance with the grinding head to produce a pulverized test substance before, during or after the step (c) of extracting the test substance by pumping extraction fluid through the extraction chamber and over the test substance to dissolve, suspend and/or distribute said test substance throughout the extraction fluid.

22. The method of claim 21 wherein the grinding head is a loose fit within the extraction chamber such that the extraction fluid and/or pulverized test substance passes around the grinding head during the grinding step (b) and/or extraction step (c).

23. The method of claim 21 wherein the grinding head is pierced with one or more holes and extraction fluid and/or pulverized test substance passes through said hole(s) during the crushing, cutting and/or grinding step (b), and/or the extraction step (c). 24-27. (canceled)

28. The method of claim 21 wherein the extraction fluid is driven through the flow cell extraction chamber before the crushing, cutting and/or grinding step.

29-37. (canceled)
